(19) United States
(12) Patent Application Publication
(10) Pub. No.: US 2010/0266723 A1
(43) Pub. Date: Oct. 21, 2010

(54) METHODS FOR FORMULATING AND CUSTOMIZING A MICRONUTRIENT SUPPLEMENT

(75) Inventors: James Alexander Bralley, III, Johns Creek, GA (US); Richard Lord, Waleska, GA (US)

Correspondence Address: E.J. ASBURY III, LLC, 1265 Lake Colony Dr., Marietta, GA, 30068, US

(73) Assignee: METAMETRIX, INC., Norcross, GA (US)

(21) Appl. No.: 12/451,623

(22) PCT Filed: Nov. 30, 2005
(86) PCT No.: PCT/US2005/043240

§ 371 Date: Jun. 21, 2010

Related U.S. Application Data
(60) Provisional application No. 60/631,765, filed on Nov. 30, 2004.

(51) Int. Cl. A23L 1/30; G06Q 50/00

(52) U.S. Cl. 426/2; 426/648; 705/2

(57) ABSTRACT

Nutritional supplements and methods for formulating and customizing such nutritional supplements are included. Also included are methods for formulating and customizing nutritional supplements to subject deficiencies for preventing disease and protecting against nutritional losses and deficiencies.

### CROSS REFERENCE TO RELATED APPLICATION

This application claims priority from copending U.S. Provisional Patent Application No. 60/631,765 entitled “A Customized Micronutrient Product” filed Nov. 30, 2004, which is hereby incorporated by reference in its entirety.

### TECHNICAL FIELD OF THE INVENTION

This invention is related to nutritional supplements and methods for formulating and customizing such nutritional supplements. More particularly, this invention relates to individually customized nutritional supplements for maintaining good health, preventing disease and protecting against nutritional losses and deficiencies and to methods for formulating and customizing such nutritional supplements.

### BACKGROUND OF THE INVENTION

The importance of adequate nutrition and nutritional balance is well known. It has been established that proper nutrition and nutritional balance can have a critical role in the maintenance of good health. In many cases, adequate nutrition may protect against the development of disease and may protect against oxidative stress. Despite the importance of adequate nutrition, the majority of the population does not get the recommended daily allowance (RDA) for most nutrients and are in need of nutritional supplementation. Further, most people have some type of nutritional insufficiency.

Over the last several decades, nutritionists have used laboratory data to make recommendations for nutrient supplementation. For example, early applications include the prescription of iron tablets to people with low hemoglobin or hemocrit levels. While people have been prescribed specific nutrients in some cases, nutritionists generally have prescribed broad spectrum multi-vitamins to the population. However, as science progresses, nutritionists are realizing that supplementing nutrients that are already at high levels may be contraindicated as there may be potential for overload. As such, nutritional science is progressing toward prediction of individual needs for specific nutrients to reduce disease risk and to optimize healing and health.

Accordingly, there is always a need for nutritional supplementation to serve a vital role in protecting against poor nutrition, nutritional insufficiency, and disease. Further, such nutritional supplementation may include the provision of a customized nutritional supplement that includes the necessary vitamins, minerals, and other nutrients that might otherwise be lacking in the subject. Such a nutritional supplement should be able to be customized to supply the proper amount of micronutrients to help prevent disease and protect against nutritional losses and deficiencies. It is to these needs, among others, that this invention is directed.

### BRIEF SUMMARY OF THE INVENTION

Briefly, this invention provides nutritional supplements customized to deficiencies in specific individuals or subjects and methods of customizing and formulating such nutritional supplements. The nutritional supplements of such embodiments are customized based on a subject's metabolite profile and are able to supply an effective amount of micronutrients adequate to help optimize the overall intake of micronutrients and to help prevent disease and deficiencies from dietary patterns.

One exemplary method for formulating and customizing a nutritional supplement to a subject's nutritional deficiencies comprises the steps of preparing quantitatively a metabolite profile of the subject in need of the nutritional supplement, comparing the metabolite profile or at least one metabolite in the metabolite profile to a reference profile to determine any nutritional deficiencies, determining a ration or effective amount of select micronutrients that may shift the subject's metabolite profile towards the reference profile, and formulating the customizing nutritional supplement by adjusting a base amount of micronutrients to have the ration or effective amount of the selected micronutrients. The customized nutritional supplement may be administered to the subject over a period of time.

Optionally, the method provides the further steps of retesting or preparing a subsequent metabolite profile of the subject after a period of time to determine whether the subject's nutritional or metabolite profile has shifted towards the reference metabolite profile, and, if necessary, the further step of adjusting the formulation.

### BRIEF DESCRIPTION OF THE DRAWINGS

FIG. 1 is a flow chart depicting one exemplary embodiment of this invention.

FIGS. 2A and 2B are chart showing associations between metabolites, micronutrients, and the respective metabolic pathway(s).

FIG. 3 represents an exemplary metabolite profile for a subject and an exemplary metabolite reference profile.

FIG. 4 is an algorithmic table for lipoic acid.

FIG. 5 is an example of a sample recommendation report outlining the formulation of a customized nutritional supplement.

### DETAILED DESCRIPTION OF THE PREFERRED EMBODIMENTS

In this specification, various terms are defined as follows:

An “effective amount” is an amount of an ingredient, component or nutrient that is nontoxic and sufficient to induce a desired effect without undue risk.

“Metabolites” are the intermediates and products of metabolism, which is the biochemical modification of chemical compounds in living organisms and cells. The term metabolite includes, but is not restricted to, small molecules.

“Micronutrients” are any elements needed by life in small quantities. Micronutrients include, but are not limited to, vitamins, minerals (including dietary minerals), and amino acids.

“Nutritional supplements” are products that supply micronutrients including amino acids; botanical supplements; enzymes; glandulars; herbal supplements; metabolic supplements; mineral supplements; and vitamin supplements. Forms of nutritional supplements include, but are not limited to, capsules, concentrates, edible bars, extracts, liquids, powders, soft gels, and tablets.

Unless otherwise defined, all technical and scientific terms used herein have the same meaning as commonly understood by one of ordinary skill in the art to which this invention pertains. Although methods and materials similar or equivalent to those described herein can be used in the practice and testing of the present invention, suitable methods and materials are described below. In addition, the materials, methods, embodiments and examples are illustrative only and not intended to be limiting.

Illustrative embodiments of this invention are directed to nutritional supplements customized to nutritional insufficiencies in specific individuals or subjects and to methods of customizing and formulating such nutritional supplements. The nutritional supplements of such embodiments are customized based on a subject's metabolite profile and are able to supply an effective amount of micronutrients adequate to help optimize the overall intake of micronutrients and to help prevent disease and deficiencies from dietary patterns.

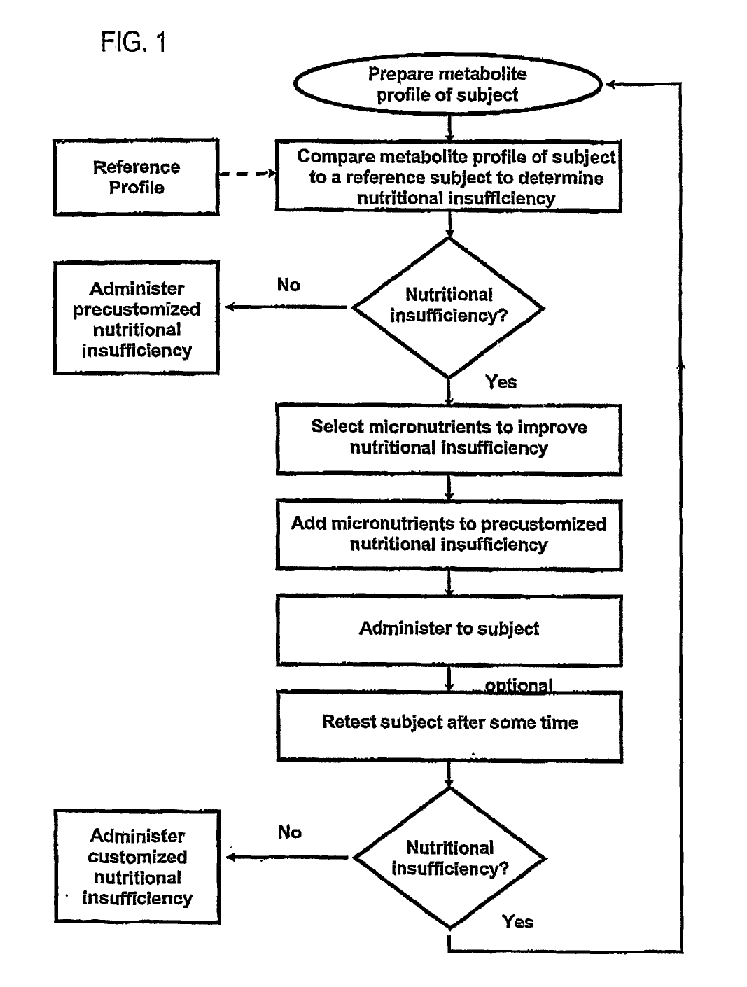

Referring now to FIG. 1, one exemplary method for formulating and customizing a nutritional supplement to a subject's nutritional insufficiencies comprises the steps of:

(a) preparing quantitatively a metabolite profile from a specimen of the subject in need of the nutritional supplement;

(b) querying the metabolite profile of the subject by comparing the metabolite profile or at least one metabolite in the metabolite profile to a reference profile to determine any nutritional insufficiencies;

(c) determining a ration or effective amount of select micronutrients that may shift the subject's metabolite profile towards the reference profile; and

(d) formulating the customizing nutritional supplement by adjusting a pre-customized base amount of micronutrients to have the ration or effective amount of the selected micronutrients. The customized nutritional supplement may be administered to the subject over a period of time.

Optionally, the method includes a further step (e) of retesting or preparing a subsequent metabolite profile of the subject after a period of time to determine whether the subject's nutritional or metabolite profile has shifted towards the reference metabolite profile. Further, if the metabolite profile of the subject has not shifted towards or enough towards the reference profile, the ration or therapeutic amount of the relevant micronutrients may be adjusted in the customized nutritional supplement. Preferably, the customized nutritional supplements can deliver micronutrients suitable to improve the subject's nutritional insufficiencies.

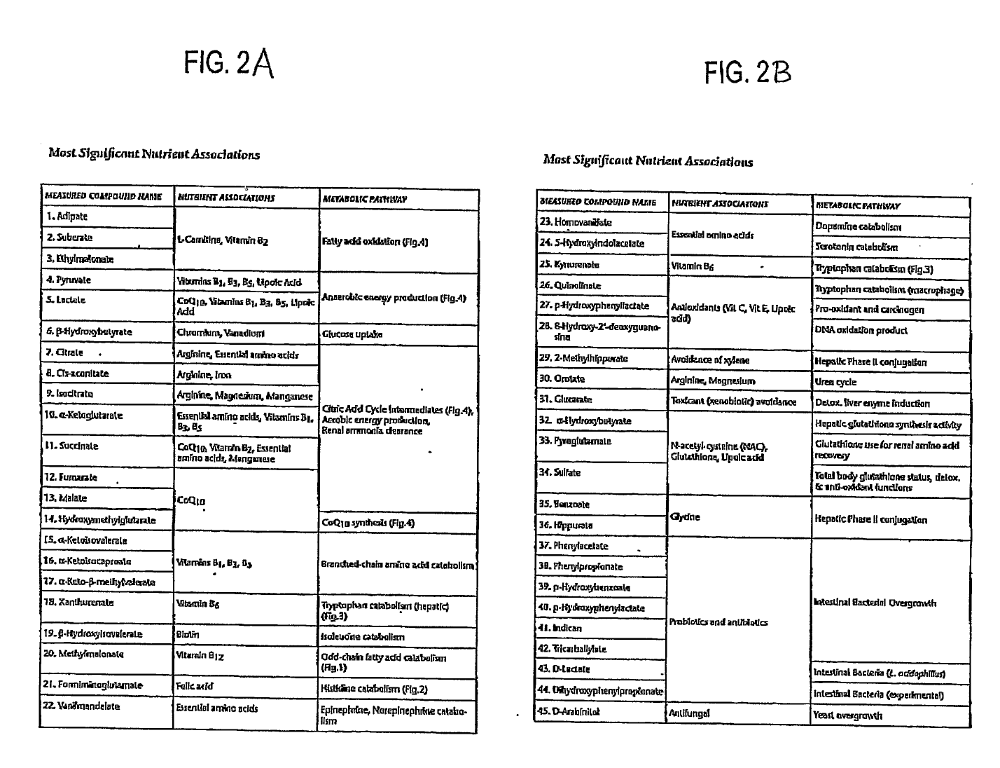

As may be seen, it may be necessary to determine which metabolites to include as part of a metabolite profile. While there are countless metabolites generated by human metabolism, it may not be necessary to select all of the metabolites. Preferably, the metabolites that are correlated with nutritional deficiencies or insufficiencies are selected to be included in the metabolite profile. The most sensitive metabolites, which are normally higher and in flux with micronutrient balance, are preferred. In such cases, this characteristic means that slight nutrient-derived cofactor changes may be reflected as significant changes in metabolite concentrations. For illustration, FIGS. 2A and 2B show exemplary associations between metabolites, micronutrients, and the respective metabolic pathway. One of ordinary skill in the art can research and select metabolites suitable to prepare a metabolite profile.

Further, the number of metabolites selected to be part of the metabolite profile can be dependant on the micronutrients to be provided by the nutritional supplement. For example, if a particular vitamin will not be a micronutrient supplemented by the customized nutritional supplement, it may not be necessary to include that the particular vitamin in the metabolite profile. In general, the number of the micronutrients to be supplemented positively correlates with the number of metabolites that should be in the metabolite profile. In addition, a larger number of metabolites may improve the results by reducing the chance for “masking”. One of ordinary skill in the art may select the number of metabolites for the metabolite profile without undue experimentation.

Once the metabolites for the metabolite profile have been selected, a reference profile may be prepared based on the data and material available in the published literature, epidemiological studies, experimental data, and the like. To prepare such a profile, one of ordinary skill in the art can ascertain a profile for a healthy or hypothetical healthy human. Such a metabolite profile can be dependant on the subject's sex, age, menopausal state, physical activity, and other factors. The RDA represents the establishment of a nutritional norm for planning and assessing dietary intake, and are the levels of intake of essential nutrients considered to be adequate to meet the known needs of practically healthy people. However, it is understood that practitioners have found and the literature discusses desired deviations from the RDA. One of ordinary skill can research and collect data to create metabolite profiles without undue experimentation.

The reference metabolite can be quantified in the metabolite profile. The quantity of each reference metabolite may be ascertained from the literature, epidemiological studies, and from research. In one embodiment, the reference literature can be first consulted and then the quantity then can be tailored with additional research, studies and/or know-how. The examples provided herewith provide one set of quantified metabolites for use in a reference profile. However, it is understood that it may be possible to achieve improved quantification of metabolites in a metabolite profile with more precise instrumentation and data.

The reference profile can be viewed as a guide for customizing and formulating the nutritional supplement. More particularly, the nutritional supplement may be customized to shift the metabolite profile of the subject towards to the reference profile. By analyzing the subject's metabolite profile and comparing this metabolite profile to the reference profile, it is possible to develop a customized nutritional supplement that can shift the subject's metabolite profile towards the reference metabolite profile. Preferably, the micronutrients in the nutritional supplement are tailored to shift the subject's profile towards the reference profile.

In one exemplary embodiment, the nutritional supplement is tailored from a pre-customized or base nutritional material having a basal level of micronutrients. The base material can comprise basic amounts of micronutrients needed for the general population and can provide an initial or pre-customized amount of micronutrients. The base level of nutrients in the nutritional supplement then may be customized, based on the subject's metabolite profile, to comprise various micronutrients to improve the nutritional condition of the subject. Further, this pre-customized material may be suitable when the subject does not require tailored nutritional supplementation.

Starting with the base material, the nutritional supplement is customized to include additional micronutrients capable of balancing or shifting the metabolite profile of the subject towards the reference profile. For example, if a metabolite or a set of metabolites is high, it is possible to add one or more nutrients to the base material to help achieve a more optimal metabolite profile. In one exemplary embodiment, the nutritional supplement was customized by tailoring the amount of micronutrients such as, but not limited to, vitamins (e.g. vitamin C, vitamin E, the vitamin B complex, vitamin K), minerals (e.g. calcium, chromium, copper, magnesium, manganese, and zinc), small molecules (e.g. folic acid, biotin, coenzyme Q10), amino acids (e.g. arginine, glycline, and N-acetyalcysteine), and metabolites (e.g. 5-hydroxytryptophan).

For example, the amount of vitamin C in the nutritional supplement may be customized based subject's metabolite profile. Vitamin C or ascorbic acid is water-soluble and is a first line of defense against free radical oxidation. Vitamin C also has a role in the synthesis of collagen. It is thought that Vitamin C can fight infection, reduce inflammation, help wounds heal faster, reduce the risk of heart disease, reduce the risk for certain cancers, and reduce the severity of colds. P-hydroxyphenyllactate in a bodily fluid (e.g. urine) may suggest the need for additional vitamin C. Preferably, between 0 and about 4000 mg of vitamin C may be added to the base material depending on the metabolite profile.

The amount of vitamin E in the nutritional supplement may be customized based on the subject's metabolite profile. Vitamin E is a lipid soluble vitamin that is necessary for the maintenance of cell membranes and for neurological health. Vitamin E also can help relieve hot flashes, relieve mastodynia, improve natural immunity, reduce the risk of certain cancers, and reduce the risk of heart disease. As used herein, Vitamin E includes, but is not limited to, alpha-tocopherol, beta-tocopherol, gamma-tocopherol, and delta-tocopherol; each of which have a “d” form (the natural form) and a “d1” form (the synthetic form). Preferably, between 0 and about 1200 IU of vitamin E may be added to the base material depending on the metabolite profile.

Vitamin B1 or thiamin may be added to the supplement based on the subject's metabolite profile. Vitamin B1 is a water-soluble vitamin needed to process carbohydrates, fat, and protein. Every cell of the body requires vitamin B1 to form the fuel the body runs on adenosine triphosphate (ATP). It is also thought that nerve cells require vitamin B1 in order to function normally. Vitamin B1 may also help keep collagen-rich connective and mucous membranes healthy, help to maintain smooth muscles, and help in the formation of blood cells. Preferably, between and about 150 IU of vitamin B1 may be added to the base material depending on the metabolite profile.

Vitamin B2 or riboflavin may be added to the nutritional supplement based on the subject's metabolite profile. Vitamin B2 is water soluble and necessary for healthy hair, nails, and mucous membranes and is involved in red blood cell formation, antibody production, and overall growth. If a person is deficient in riboflavin, compounds such as succinate, adipate, suberate, and ethylmalomate may be high in bodily fluids such as urine. Succinate may be one marker for the need for Vitamin B2 supplementation. Preferably, between 0 and 50 mg of vitamin B2 may be added to the base material depending on the metabolite profile and the micronutrients of pre-customized material.

Vitamin B3 or niacin may be added to the nutritional supplement based on the subject's metabolite profile. Vitamin B3 is water soluble and may help in the production of sex hormones, dilate blood vessels, and reduce the risk of heart disease. Niacin is the generic name for a group of compounds which exhibit niacin activity, and includes niacinamide and nicotinic acid. Lactate may be one marker for the need for Vitamin B3 supplementation. Preferably, between 0 and about 100 mg of vitamin B3 may be added to the base material depending on the metabolite profile.

Vitamin B5 or pantothenic acid may be added to the nutritional supplement based on the subject's metabolite profile. Vitamin B5 is important for the production of adrenal gland hormones and metabolism. Pantothenic acid may be in the form of d-calcium pantothenate. α-ketoglutaric acid may be one marker for need for vitamin B5. Preferably, between 0 and about 100 mg of vitamin B5 may be added to the base material depending on the metabolite profile.

Vitamin B6 or pyridoxine may be added to the nutritional supplement based on the subject's metabolite profile. Vitamin B6 is water soluble and may be involved in the production of nucleic acids and in the utilization of amino acids. Inadequate vitamin B6 is one factor that can lead to increased concentrations of kynurenate and xanthurenic acid. Pyridoxine includes pyridoxine, pyridoxamine, and pyridoxal. kynurenate may be one marker for the need for Vitamin B6 supplementation. Preferably, between 0 and 200 mg of vitamin B6 may be added to the base material depending on the metabolite profile.

Vitamin B12 (or the cobalamin) may be added to the nutritional supplement based on the subject's metabolite profile. Vitamin B12 may be necessary for metabolism, the function of the nervous system, the metabolism of folic acid, and the production of red blood cells. Vitamin B12 includes the three active forms of cobalamin, which are cyanocobalamin, hydroxocobalamin, and nitrocobalamin. Methylmalonate is one sensitive, functional marker for vitamin B12 and high levels of methylmalonate can be indicative of vitamin B12 insufficiency. Preferably, between 0 and 1000 mg of vitamin B12 may be added to the base material depending on the metabolite profile.

Folic acid also may be added to the nutritional supplement based on the subject's metabolite profile. Folic acid is a B-complex vitamin (once called vitamin M) that is important in preventing neural tube defects in the developing human fetus. Folic acid also can help lower levels of homocysteine, which is important as high levels of homocysteine are statistically associated with a risk of ischaemic heart disease. Formiminoglutamic acid is a compound made from the histidine and insufficiency of folic acid can lead to higher levels of formiminoglutamic acid in the bodily fluids such as urine. Preferably, between 0 and 1200 mg of folic acid may be added to the base material depending on the metabolite profile and the micronutrients in the base material.

Biotin also may be added to the nutritional supplement based on the subject's metabolite profile. Biotin may be necessary for the metabolism of carbohydrates, proteins, and fats and is needed for healthy skin and hair. Until recently, biotin insufficiency was difficult to determine in humans because this vitamin insufficiency affects health in ways that mimic other conditions. β-hydroxyisovalerate is a specific and sensitive metabolic marker for functional biotin insufficiency. Preferably, between 0 and 1200 mcg of biotin may be added to the base material depending on the metabolite profile and the micronutrients in the base material.

Calcium also may be added to the nutritional supplement based on the subject's metabolite profile. Preferably, between 0 and 800 of calcium may be added to the base material depending on the metabolite profile. Calcium, e.g. 350 mg, may be added to the nutritional supplement when the metabolite profile shows elevated orotate and succinate levels.

Magnesium also may be added to the nutritional supplement based on the subject's metabolite profile. Magnesium is an essential metal. Many enzymes require the presence of magnesium ions for their catalytic action, especially enzymes utilizing ATP. Inadequate magnesium intake frequently causes muscle spasms, and has been associated with cardiovascular disease, diabetes, high blood pressure and osteoporosis. Useful pharmaceutically acceptable magnesium compounds include, but are not limited to, magnesium stearate, magnesium carbonate, magnesium oxide, magnesium hydroxide, magnesium sulfate, and combinations thereof. Orotate and succinate may be markers for magnesium insufficiency. Preferably, between 0 and 800 mg of magnesium may be added to the base material depending on the metabolite profile and the micronutrients in the pre-customized material.

Selenium also may be added to the nutritional supplement based on the subject's metabolite profile. Selenium may reduce the risk of heart disease, reduce the risk of cancer, protect against metal poisoning, and be synergistic with vitamin E. A higher level of selenium may be required to fight the high level of free-radicals produced by athletes. Preferably, between 0 and 200 mcg of selenium may be added to the base material depending on the metabolite profile.

Copper also may be added to the nutritional supplement based on the subject's metabolite profile. Preferably, between 0 and 2 mg of copper may be added to the base material depending on the metabolite profile.

Manganese also may be added to the nutritional supplement based on the subject's metabolite profile. Manganese is an essential nutrient and reduced levels may lead to slowed blood clotting, skin problems, lowered cholesterol levels, and alterations in metabolism. β-hydroxybutyric acid may be a marker for manganese insufficiency. Preferably, between 0 and 4 mg of manganese may be added to the base material depending on the metabolite profile.

Chromium also may be added to the nutritional supplement based on the subject's metabolite profile. Chromium can assist in the regulation of glucose metabolism and the synthesis of fatty acids. Further, chromium may assist in transporting proteins, in lowering LDL blood levels, and in raising high density lipoproteins blood levels. Useful pharmaceutically acceptable chromium compounds include, but are not limited to, yeast-bound chromium, GTF chromium, and niacin-bound chromium. Elevated (3-hydroxybutyrate is a metabolite that may be a marker for the need for chromium. Preferably, between 0 and 300 mcg of chromium may be added to the base material depending on the metabolite profile and the micronutrients in the base material.

5-hydroxytryptophan also may be added to the nutritional supplement based on the subject's metabolite profile. As 5-hysroxyindoleacetate is a marker of serotonin metabolism, an excess of this metabolite may indicate that lower levels of 5-hydroxytryptophan. Preferably, between 0 and 400 mg of 5-hydroxytryptophan also may be added to the base material depending on the metabolite profile.

Arginine also may be added to the nutritional supplement based on the subject's metabolite profile. High citrate, isocitrate, cis-aconitate, or orotate may indicate arginine insufficiency. Preferably, between 0 and 3000 mg of arginine may be added to the base material depending on the metabolite profile.

Carnitine (L-carnitine) also may be added to the nutritional supplement based on the subject's metabolite profile. Preferably, between 0 and 800 mg of carnitine may be added to the base material depending on the metabolite profile.

Coenzyme Q10, also known as ubiquinone, may be added to the nutritional supplement based on the subject's metabolite profile. Coenzyme Q10, also known as ubiquinone, is an antioxidant and may aid in metabolic reactions. Coenzyme Q10 is depleted in people taking lovastatin and pravastatin which are cholesterol lowering drugs. Elevations of hydroxymethylglutarate can reveal a block in the synthesis of coenzyme Q10. Other functional marker include lactate, succinate, fumarate, and malate. Preferably, between 0 and 250 mg of coenzyme Q10 may be added to the base material depending on the metabolite profile.

Lipoic acid may be added to the nutritional supplement based on the subject's metabolite profile. Lipoic acid has been regarded as a coenzyme in the oxogluate dehyrodenase complex of the citric acid cycle. It is sulfur containing and is involved in metabolism, antioxidant protection, and insulin formation. It protects cell membranes by interacting with vitamin C and glutathione. Pyruvate and lactate in bodily fluids (such a urine) may be markers the need for lipoic acid. Preferably, between 0 and 600 mg of lipoic acid may be added to the base material depending on the metabolite profile and micronutrients in the pre-customized material.

N-acetyl-1-cysteine may be added to the nutritional supplement based on the subject's metabolite profile. N-Acetyl-1-cysteine is a natural sulfur-containing amino acid derivative and has free radical scavenging activity, stimulates glutathione synthesis and promotes detoxification. Pyroglutamate sulfates are makers for the need for N-acetyl-1-cysteine. Preferably, between 0 and 800 mg of N-acetyl-1-cysteine may be added to the base material depending on the metabolite profile.

One advantage of preferred embodiments of the present invention is that it can be used to administer multiple micronutrients based on the analysis of a single body fluid (e.g. group consisting of blood, urine, spinal fluid, or combination thereof). For example, it is possible to analyze the metabolites in a single specimen of urine to prepare a nutritional supplement deliver an array of micronutrients. However, it is within the scope of this invention to use a profile based on multiple body fluids.

It is understood that exemplary embodiments of this invention discussed herein can include other micronutrients that are not discussed herein in detail but are nonetheless placed into nutritional supplements. Such micronutrients include, but are not limited to, minerals (e.g. zinc), carotenoids, lycopene, glucosamine, herbal extracts or customized diets where the subject is guided to food sources of the nutrients. Other micronutrients are known to those with ordinary skill the art and may be added without undue experimentation.

It is understood that the specific micronutrients included into in the customized nutritional supplement may change as more information as science and nutritional science progresses. It is contemplated that additional nutrients may be added to the supplement as such discovered or discovered to be useful. However, it is understood that any range provided herein may change with the progression of science and as the nutritional standards.

The customized nutritional supplement may be packaged and delivered by the traditional delivery mechanisms. For example, the nutritional supplements may be delivered in tablets, powders, granules, beads, chewable lozenges, capsules, liquids, or similar conventional dosage forms, using conventional equipment and techniques known in the art.

Further, the nutritional supplements may be manufactured with conventional excipients. Such excipients include, but are not limited to, binders, lubricants, oils, sugar polymers, suspending agents, absorbents, preservatives, surfactants, colorants, coating, and favorant.

For preparing the composition from the compounds may be prepared, e.g., using inert, pharmaceutically acceptable carriers known to those skilled in the art. As nutritional supplements are traditionally ingested, the preferred forms of the customized nutritional supplement of this invention include powders, tablets, dispersible granules, capsules, cachets, and the like. A solid carrier is suitably for one or more substances may also act as diluents, flavoring agents, solubilizers, lubricants, suspending agents, binders or tablet disintegrating agents. The solid carrier material also can include encapsulating material. In powders, the carrier is finely divided active compounds. In a tablet, the active compound is mixed with the carrier having the necessary binding properties in suitable proportions and compacted in the shape and size desired. Suitable solid carriers include, but are not limited, to magnesium carbonate, magnesium stearate, talc, sugar, lactose, pectin, dextrin, starch, gelatin, tragacanth, methylcellulose, sodium carboxymethylcellulose, a low melting wax, cocoa butter, mixtures thereof and the like.

Liquid form preparations include, but are not limited to, solutions, suspensions, and emulsions. Aqueous solutions suitable for oral use are prepared by dissolving the active component in water or other suitable liquid and adding suitable colorants, flavors, stabilizing agents, and thickening agents as desired. Aqueous solutions suitable for oral use may also be made by dispersing the finely divided active component in water or other suitable liquid with viscous material, such as natural or synthetic gums, resins, methylcellulose, sodium carboxymethylcellulose, and other suspending agents known in the art.

Also included are solid form preparations which are intended to be converted, shortly before use, to liquid form preparations for either oral or parental administration. Such liquid forms include solutions, suspensions, and emulsions. These particular solid form preparations are provided in unit dose form and as such are used to provide a single liquid dosage unit. Alternatively, sufficient solid preparation may be provided so that after conversion to liquid form, multiple subject liquid doses may be obtained by measuring predetermined volumes of the liquid form preparation as with a syringe, teaspoon, or other volumetric contained.

Determination of the proper dosage for a particular situation is normally done by the practitioner. For example, the total daily dosage may be divided and administered in portions over period of time such as a day. In some cases, periods less than or more than a day may be suitable. Controlled and uncontrolled release formulations are also included within this invention.

Although the products of the invention are preferably intended for administration to humans, it will be understood that the formulation may also be adapted for the use with veterinary therapy for animals.

### EXAMPLES

The following examples of this invention are provided by way of explanation and illustration.

### Example 1

A customized nutritional supplement was formulated by preparing metabolite profile of the subject using the subject's urine, comparing that metabolite profile of that subject to a reference profile to determine specific nutritional insufficiencies, determining the effective amount of nutrients to provide to that subject to shift that subject's metabolite profile towards the reference profile; and formulating the customizing nutritional supplement by adjusting the base amount of micronutrients in the pre-customized supplement to have the effective amount of the selected micronutrients.

### Example 2

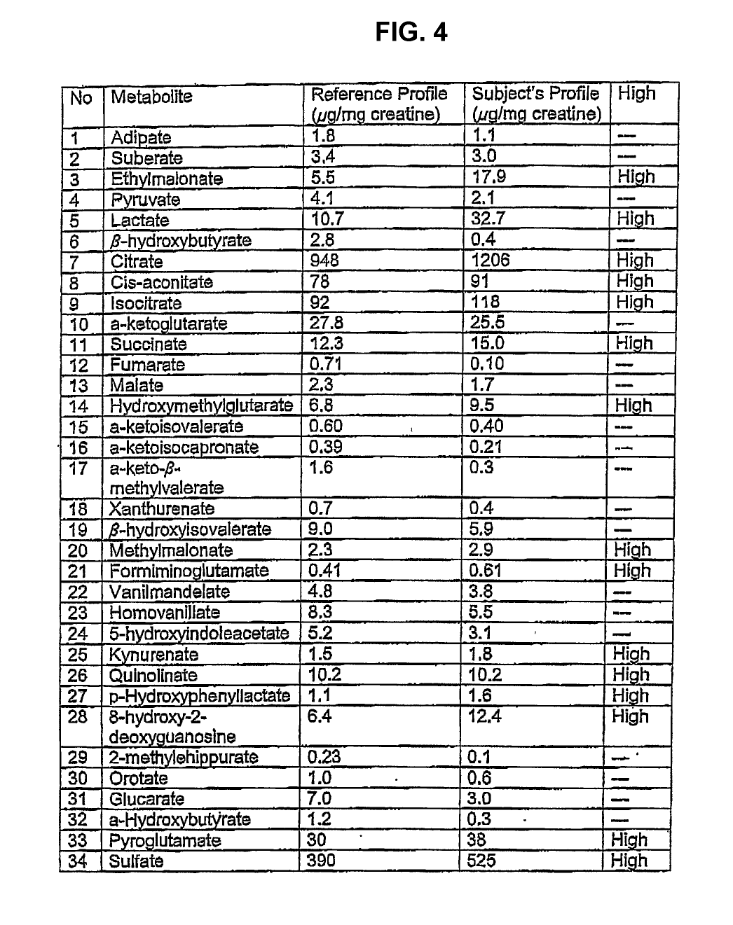

FIG. 4 shows the metabolites selected for preparing a metabolite profile. These metabolites were 2-methylhippuric acid (2-MeHipp), 5-hydroxyindoleacetic acid (5HIAA), hexanedioic acid (Adipate), 2-ketoglutaric acid (a-ketoglutaric acid), 2-ketoisocaproic acid (aKisocap), 2-ketoisovaleric acid (aKisoval), 2-keto-3-methylvaleric acid (aKβMeVal), 2-Hydroxybutyric acid (aOhBut), D-arabinitol (arabinitol), benzoic acid (benzoate), cis-Aconitic acid (cis Acon), Citric acid (citrate) 8-hydroxy-2′-deoxyguanosine (DeOxGuan), 2-(2,3-Dihydroxyphenyl), propionnic acid (DiOHPhPro), D-Lactic acid (D-Lactate), Ethylmalonic acid, formiminoglutamic acid, fumaric acid (Furmarate), glucaric acid (glucarate), hippuric acid (hippurate), hydroxymethylglutaric acid (HMG), homovanillic acid (HVA), 1h-Indol-3-ol hydrogen sulfate ester (Indican), Isocitric acid (Isocitrate), Kynurenic acid (Kynurenate), 2-Hydroxypropanoic acid (Lactate), malic acid (malate), methylmalonic acid (methylmalonate), orotic acid (orotate), phenylacetic acid (Phenylacetate), 2-Phenylpropionic acid (Phenylpropionate), 4-Hydroxybenzoic acid (p-hydroxybenzoate), 4-Hydroxyphennylacetic acid (p-hydroxyphenylacetate), 4-Hydroxyphenyllacetic acid (pOHPhLac), 2-pyrrolidone-5-carboxylic acid (Pyroglut), 2-Ketopropanoic acid Pyruvate, Quinolinic acid (Quin), 2,3-Pyridinedicarboxylic acid (Quinolinate), 3-Hydroxybutyric acid (β-OHButyrate), 3-Hydroxyisovaleric acid (β-OHiVal), Octanedioic acid (Suberate), Succinic acid (Succinate), Tricarballilic acid (Tricarballylate), Vanilmandelic acid (VMA), and Xanthurenic acid (Xanth). These metabolites were selected, in part, because fluxes in these metabolites are known to be associated with nutritional insufficiencies.

### Example 3

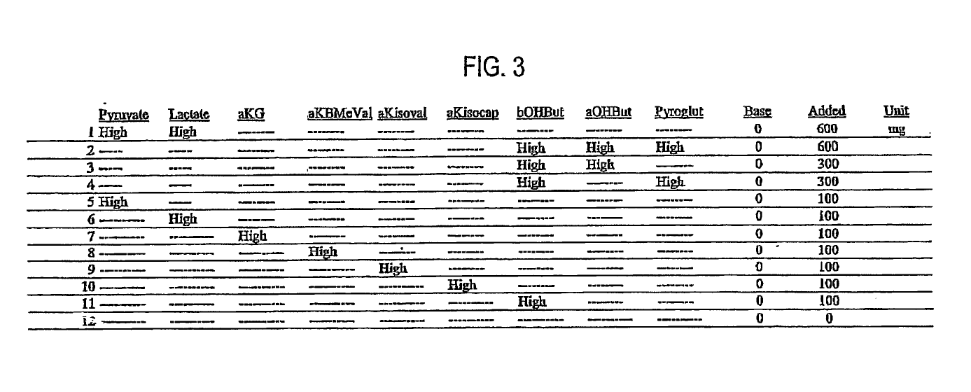

FIG. 3 also shows that a reference profile prepared based on data available the literature and from experimental data. These tablets were created by first researching the association between nutrient insufficiencies and metabolites. Further, the literature values were then tailored based on studies to develop the amounts of the additional micronutrients. The tables were also supplement by the inventors' research. The rows in the table were arranged, in part, according to metabolite deviation and the degree of insufficiency. As may be seen, the data corresponds to units of μg of the specific metabolite per mg of creatinine.

### Example 4

FIG. 3 shows a comparison of an exemplary reference metabolite profile and a subject's metabolite profile. As may be seen, a metabolite was determined to “high” when the level of the specific metabolite in the subject's metabolite profile was above that in the reference profile.

### Example 5

The base or pre-customized nutritional material contains a basal level of micronutrients. In this example, the pre-customized nutritional material comprises 2500 IU of vitamin A (palmitate), 5500 IU of vitamin A (beta carotene), 250 IU of vitamin C, 400 IU of Vitamin D-3, 100 IU of vitamin E, 5 IU of thiamin, 5 IU of vitamin B-2, 25 IU of niacin, 25 IU of pantothenic acid, 15 IU of vitamin B-6, 50 IU of vitamin B-12, 400 IU of folic acid, 100 IU of biotin, 100 IU of vitamin K, 75 IU of iodine, 500 IU of calcium, 250 μl of magnesium, 15 mg of zinc, 1.5 mg of copper, 5 mg of manganese, 200 mcg of chromium, and 200 mcg of selenium, 25 mcg of moydenum, 1 mg of boron, 200 citric acid, and malic acid.

### Examples 6-26

The nutritional supplement suitable for the subject was customized based on various micronutrient insufficiencies and based on the subject's metabolite profile.

The tables below provide an algorithm to determine whether to supplement the pre-customized level of a nutrient is in need of supplementation. Each row is a step in the analysis and may be viewed as a guide for customization of the nutritional supplement. For example, if the metabolites identified as “high” in the first row are high in the subject, then the quantity of the micronutrient is added to the pre-customized supplement. If the metabolites identified as “high” in the first row are not high in the subject, then the next row is utilized for customization. This step is repeated until the last row, which generally means additional supplementation of that micronutrient is not necessary. The analysis began by starting and checking the metabolites in row 1.

### Example 6

The amount of vitamin C in the nutritional supplement was customized based subject's metabolite profile. As shown in Table 1, the nutritional supplement was adjusted based on the quantities of quinolinate, suberate, succinate, 2-pyrrolidone-carboxylic acid, p-hydroxyphenyllactate, and 8-hydroxy-2-deoxyguanosine. In this case, 3000 mg of vitamin C was added to the base material as p-hydroxyphenyllactate and 8-hydroxy-2-deoxyguanosine were above the reference levels.

TABLE 1

| | | | | | | | Base | Added |
|---|---|---|---|---|---|---|---|---|
| | Quinolinate | Suberate | Succinate | Pyroglut | pOHPhLac | DeOxGuan | (mg) | (mg) |
| 1 | — | — | — | — | High | High | 250 | 3000 |
| 2 | High | — | High | — | — | — | 250 | 2000 |
| 3 | — | — | — | — | High | — | 250 | 2000 |
| 4 | — | — | — | — | — | High | 250 | 2000 |
| 5 | — | — | High | High | — | — | 250 | 1000 |
| 6 | — | High | High | — | — | — | 250 | 1000 |
| 7 | High | — | — | — | — | — | 250 | 1000 |
| 8 | — | High | — | — | — | — | 250 | 500 |
| 9 | — | — | High | — | — | — | 250 | 500 |
| 10 | — | — | — | High | — | — | 250 | 500 |
| 11 | — | — | — | — | — | — | 250 | 0 |

### Example 7

The amount of vitamin E in the nutritional supplement may be customized based on the subject's metabolite profile. As shown in Table 2, the base amount of vitamin E in the nutritional supplement was adjusted based on the quantities of quinolinate, suberate, succinate, pyroglutamate, 4-hydroxyphenyllactic acid, and 8-hydroxy-2-deoxyguanosine. In this case, 800 IU of vitamin E was added to the base material as p-hydroxyphenyllactate and 8-hydroxy-2-deoxyguanosine were above the reference levels.

TABLE 2

| | | | | | | | Base | Added |
|---|---|---|---|---|---|---|---|---|
| | Quinolinate | Suberate | Succinate | Pyroglut | pOHPhLac | DeOxGuan | (IU) | (IU) |
| 1 | — | — | — | — | High | High | 100 | 800 |
| 2 | High | — | High | — | — | — | 100 | 400 |
| 3 | — | — | — | — | High | — | 100 | 400 |
| 4 | — | — | — | — | — | High | 100 | 400 |
| 5 | — | — | High | High | — | — | 100 | 300 |
| 6 | — | High | High | — | — | — | 100 | 300 |
| 7 | High | — | — | — | — | — | 100 | 200 |
| 8 | — | High | — | — | — | — | 100 | 200 |
| 9 | — | — | High | — | — | — | 100 | 200 |
| 10 | — | — | — | High | — | — | 100 | 200 |
| 11 | — | — | — | — | — | — | 100 | 0 |

### Example 8

The amount of vitamin B1 in the nutritional supplement may be customized based on the subject's metabolite profile. As shown in Table 3, the base amount of vitamin B1 in the nutritional supplement can be adjusted based on the quantities of a-ketoglutaric acid, 2-ketoisocaproic acid, pyruvate, 2-keto-methylvaleric acid, 2-ketoisovaleric acid, and lactate. In this case, 5 IU of vitamin B1 was added to the base material as lactate was above the reference levels (see row 8).

TABLE 3

| | | | | | | | Base | Added |
|---|---|---|---|---|---|---|---|---|
| | a-KG | aKisocap | Pyruvate | aKβMeVal | aKisoval | Lactate | (IU) | (IU) |
| 1 | — | High | High | High | High | — | 5 | 100 |
| 2 | — | High | High | — | High | — | 5 | 100 |
| 3 | High | — | High | — | — | — | 5 | 20 |
| 4 | — | — | High | — | — | — | 5 | 5 |
| 5 | — | — | — | High | — | — | 5 | 5 |
| 6 | — | High | — | — | — | — | 5 | 5 |
| 7 | — | — | — | — | High | — | 5 | 5 |
| 8 | — | — | — | — | — | High | 5 | 5 |
| 9 | High | — | — | — | — | — | 5 | 5 |
| 10 | — | — | — | — | — | — | 5 | 0 |

### Example 9

The amount of vitamin B2 in the nutritional supplement may be customized based on the subject's metabolite profile. Table 4 shows that the base amount of vitamin B2 in the nutritional supplement can be adjusted based on the quantities of succinate, adipate, suberate, ethylmalonic acid, pyruvate, lactate, α-ketoglutaric acid, 2-ketoisovaleric acid*, aKisocap* and 2-keto-methylvaleric acid*. In this case, 10 IU of vitamin B2 was added to the base material as succinate was above the reference levels (see row 3).

TABLE 4*

| | | | | | | | | Base | Added |
|---|---|---|---|---|---|---|---|---|---|
| | Succinate | Adipate | Suberate | EtMal | Pyruvate | Lactate | aKG | (mg) | (mg) |
| 1 | High | High | High | High | — | — | — | 5 | 50 |
| 2 | — | High | High | High | — | — | — | 5 | 20 |
| 3 | High | — | — | — | — | — | — | 5 | 10 |
| 4 | — | — | — | — | High | — | — | 5 | 10 |
| 5 | — | — | — | — | — | High | — | 5 | 10 |
| 6 | — | — | — | — | — | — | High | 5 | 10 |
| 7 | — | — | — | — | — | — | — | 5 | 10 |
| 8 | — | — | — | — | — | — | — | 5 | 0 |

(*Data for 2-ketoisovaleric acid, aKisocap and aKβMeVal are not shown)

### Example 10

The amount of vitamin B3 in the nutritional supplement may be customized based on the subject's metabolite profile. Table 5 shows that the base amount of vitamin B3 in the nutritional supplement may be adjust based on the relative quantities of aKisocap, 2-ketoisovaleric acid, 2-keto-3-methylvaleric acid, pyruvate, lactate, and/or α-ketoglutaric acid. In this case, 20 mg of vitamin B3 was added to the base material as lactate was above the reference levels (see row 6).

TABLE 5

| | | | | | | | Base | Added |
|---|---|---|---|---|---|---|---|---|
| | aKisocap | aKisoval | aKβMeVal | Pyruvate | Lactate | aKG | (mg) | (mg) |
| 1 | High | High | High | — | — | — | 25 | 70 |
| 2 | High | — | — | — | — | — | 25 | 20 |
| 3 | — | High | — | — | — | — | 25 | 20 |
| 4 | — | — | High | — | — | — | 25 | 20 |
| 5 | — | — | — | High | — | — | 25 | 20 |
| 6 | — | — | — | — | High | — | 25 | 20 |
| 7 | — | — | — | — | — | High | 25 | 20 |
| 8 | — | — | — | — | — | — | 25 | 0 |

### Example 11

The amount of vitamin B5 in the nutritional supplement may be customized based on the subject's metabolite profile. Table 6 shows that the base amount of vitamin B5 in the nutritional supplement may be adjust based on the relative quantities of 2-keto-3-methylvaleric acid, a-kicaproate, a-kivalerate, pyruvate, a-ketoglutaric acid and/or lactate. In this case, 25 mg of vitamin B5 was added to the base material as lactate was above the reference levels (see row 7).

TABLE 6

| | a-KβMeVal | a-kicaproate | a-kivalerate | Pyruvate | aKG | Lactate | Base | Added |
|---|---|---|---|---|---|---|---|---|
| 1 | High | High | High | High | — | — | 25 | 100 |
| 2 | — | — | — | High | High | — | 25 | 50 |
| 3 | — | High | High | — | — | — | 25 | 50 |
| 4 | High | — | — | — | — | — | 25 | 25 |
| 5 | — | High | — | — | — | — | 25 | 25 |
| 6 | — | — | High | — | — | — | 25 | 25 |
| 7 | — | — | — | — | High | — | 25 | 25 |
| 8 | — | — | — | — | — | High | 25 | 25 |
| 9 | — | — | — | — | — | — | 25 | 0 |

### Example 12

The amount of vitamin B6 in the nutritional supplement may be customized based on the subject's metabolite profile. Table 7 shows that the base amount of vitamin B6 in the nutritional supplement may be adjust based on the relative quantities of kynurenate and/or xanthurenic acid. In this case, 60 mg of vitamin B6 was added to the base material as kynurenate was above the reference levels (see row 3).

TABLE 7

| | | | Base | Added |
|---|---|---|---|---|
| | Kynurenate | Xanth | (mg) | (mg) |
| 1 | High | High | 15 | 100 |
| 2 | | High | 15 | 80 |
| 3 | High | | 15 | 60 |
| 4 | — | — | 15 | 0 |

### Example 13

The amount of vitamin B12 in the nutritional supplement may be customized based on the subject's metabolite profile. Table 8 shows that the base amount of vitamin B12 in the nutritional supplement may be adjust based on the relative quantities of methylmalonate and formiminoglutamate. In this case, 800 mg of vitamin B12 was added to the base material as methylmalonate and formiminoglutamate were above the reference levels (see row 1).

TABLE 8

| | | | Base | Added |
|---|---|---|---|---|
| | Methylmalonate | FIGLU | (mcg) | (mcg) |
| 1 | High | High | 50 | 800 |
| 2 | High | — | 50 | 800 |
| 3 | — | High | 50 | 500 |
| 4 | — | — | 50 | 0 |

### Example 13

The amount of vitamin folic in the nutritional supplement may be customized based on the subject's metabolite profile. Folic acid, 800 mg, may be added to the base material when formiminoglutamate were above the reference levels. In this case, formiminoglutamate was above the reference level.

### Example 14

The amount of biotin in the nutritional supplement may be customized based on the subject's metabolite profile. Biotin, 800 mg, may be added to the base material when β-OHiVal is above the reference level. In this case, β-OHiVal was not high.

### Example 15

The amount of calcium in the nutritional supplement may be customized based on the subject's metabolite profile. Calcium, 350 mg, may be added to the base material when orotate and succinate are above the reference level. In this case, orotate and succinate were not high or above the reference level.

### Example 16

The amount of magnesium in the nutritional supplement may be customized based on the subject's metabolite profile. Table 9 shows that the base amount of magnesium in the nutritional supplement may be adjust based on the relative quantities of orotate, succinate, b-OHBut, and quinolinic acid. In this case, 200 mg of magnesium was added to the base material as quinolinic acid was above the reference level (see row 4).

TABLE 9

| | | | | | | Added |
|---|---|---|---|---|---|---|
| | Orotate | Succinate | b-OHBut | Quin | Base (mg) | (mg) |
| 1 | High | High | — | — | 250 | 400 |
| 2 | High | — | — | — | 250 | 200 |
| 3 | — | — | High | — | 250 | 200 |
| 4 | — | — | — | High | 250 | 200 |
| 5 | — | — | — | — | 250 | 0 |

### Example 17

The amount of selenium in the nutritional supplement may be customized based on the subject's metabolite profile. Table 10 shows that the base amount of selenium in the nutritional supplement may be adjust based on the relative quantities of quiolinate, suberate, succinate and 2-pyrrolidone-carboxylic acid. In this case, 200 mcg of selenium was added to the base material as quinolinate and succinate were above the reference level (see row 1).

TABLE 10

| | | | | | Base | Added |
|---|---|---|---|---|---|---|
| | Quinolinate | Suberate | Succinate | Pyroglut | (mcg) | (mcg) |
| 1 | High | — | High | — | 100 | 200 |
| 2 | — | — | High | High | 100 | 100 |
| 3 | — | High | High | — | 100 | 100 |
| 4 | High | — | — | — | 100 | 100 |
| 5 | — | High | — | — | 100 | 50 |
| 6 | — | — | High | — | 100 | 50 |
| 7 | — | — | — | High | 100 | 50 |
| 8 | — | — | — | — | 100 | 0 |

### Example 18

The amount of copper in the nutritional supplement may be customized based on the subject's metabolite profile. Copper, 2 mg, may be added to the base material when vanilmandelic acid and homovanillic acid are above the reference level. In this case, vanilmandelic acid and homovanillic acid were not high or above the reference level.

### Example 19

The amount of manganese in the nutritional supplement may be customized based on the subject's metabolite profile. Manganese, 2 mg, may be added to the base material when β-OHButyate are above the reference level. In this case, β-OHButyate was not high or above the reference level.

### Example 20

The amount of Chromium in the nutritional supplement may be customized based on the subject's metabolite profile. Chromium, 200 mcg, may be added to the base material when β-OHButyate is above the reference level. In this case, β-OHButyate was not high or above the reference level.

### Example 21

The amount of 5-hydrozytrypophan in the nutritional supplement may be customized based on the subject's metabolite profile. 5-hydrozytrypophan, 200 mg, may be added to the base material when 5-hysroxyindoleacetate is above the reference level (an excess of this metabolite may indicate that lower levels of 5-hydroxytrypophan). In this case, 5-hysroxyindoleacetate was not high or above the reference level.

### Example 22

The amount of arginine in the nutritional supplement may be customized based on the subject's metabolite profile. Table 11 shows that the base amount of arginine in the nutritional supplement may be adjust based on the relative quantities of citrate, cis-Aconitic, isocitrate and/or orotate. In this case, 1000 mg of arginine was added to the base material as cis-Aconitic and isocitrate were above the reference level (see row 2).

TABLE 11

| | | cis | | | Base | Added |
|---|---|---|---|---|---|---|
| | Citrate | Acon | Isocitrate | Orotate | (mg) | (mg) |
| 1 | High | — | — | High | 0 | 2000 |
| 2 | — | — | — | High | 0 | 1000 |
| 3 | — | High | High | — | 0 | 1000 |
| 4 | High | — | — | — | 0 | 500 |
| 5 | — | — | High | — | 0 | 500 |
| 6 | — | High | — | — | 0 | 500 |
| 7 | — | — | — | — | 0 | 0 |

### Example 23

The amount of carnitine (L-carnitine) in the nutritional supplement may be customized based on the subject's metabolite profile. Table 12 shows that the base amount of carnitine in the nutritional supplement may be adjust based on the relative quantities of adipate, suberate, and/or ethylmalonate. In this case, 400 mg of carnitine was added to the base material as ethylmalonate was above the reference level (see row 5).

TABLE 12

| | | | Ethyl | | Added |
|---|---|---|---|---|---|
| | Adipate | Suberate | Mal | Base (mg) | (mg) |
| 1 | High | High | — | 0 | 800 |
| 2 | High | — | High | 0 | 800 |
| 3 | — | High | High | 0 | 800 |
| 4 | High | — | — | 0 | 400 |
| 5 | — | — | High | 0 | 400 |
| 6 | — | High | — | 0 | 400 |
| 7 | — | — | — | 0 | 0 |

### Example 24

The amount of coenzyme Q10 in the nutritional supplement may be customized based on the subject's metabolite profile. Table 13 shows that the base amount of coenzyme Q10 in the nutritional supplement may be adjust based on the relative quantities of hydroxymethylglutaric acid, succinate, formate, malate, lactate, and/or α-ketoglutaric acid. In this case, 60 mg of coenzyme Q10 was added to the base material as hydroxymethylglutaric acid and lactate were above the reference level (see row 5).

TABLE 13

| | HMG | Succinate | Fumarate | Malate | Lactate | aKG | Base (mg) | Added (mg) |
|---|---|---|---|---|---|---|---|---|
| 1 | High | High | High | High | High | — | 0 | 180 |
| 2 | — | High | High | High | — | — | 0 | 120 |
| 3 | High | — | High | High | — | — | 0 | 120 |
| 4 | High | High | High | — | — | — | 0 | 120 |
| 5 | High | — | — | — | High | — | 0 | 60 |
| 6 | — | High | — | — | — | — | 0 | 60 |
| 7 | — | — | High | — | — | — | 0 | 60 |
| 8 | — | — | — | High | — | — | 0 | 60 |
| 9 | Low | — | — | — | — | — | 0 | 30 |
| 10 | High | — | — | — | — | — | 0 | 30 |
| 11 | — | — | — | — | High | — | 0 | 30 |
| 12 | — | — | — | — | — | High | 0 | 30 |
| 13 | — | — | — | — | — | — | 0 | 0 |

### Example 25

The amount of Lipoic acid in the nutritional supplement may be customized based on the subject's metabolite profile. Table 14 (FIG. 4) shows that the base amount of Lipoic acid in the nutritional supplement may be adjust based on the relative quantities of pyruvate, lactate, α-ketoglutaric acid, 2-keto-3-methylvaleric acid, 2-ketoisovaleric acid, aKisocap, and/or β-OHButyate. In this case, 100 mg of Lipoic acid was added to the base material as lactate was above the reference level (see row 6).

### Example 26

The amount of N-acetyl-1-cysteine in the nutritional supplement may be customized based on the subject's metabolite profile. Table 15 shows that the base amount of N-acetyl-1-cysteine in the nutritional supplement may be adjust based on the relative quantities of quinolinate, glucarate, 2-hydroxybutyric acid, and/or sulfate. In this case, N-acetyl-1-cysteine was added to the base material as cis-Aconitic and isocitrate were above the reference level (see row 2).

TABLE 15

| | | | | | Base | Added |
|---|---|---|---|---|---|---|
| | Pyroglut | Glucarate | aOhBut | Sulfate | (mg) | (mg) |
| 1 | High | High | — | Low | 0 | 800 |
| 2 | High | High | — | — | 0 | 750 |
| 3 | High | — | — | Low | 0 | 750 |
| 4 | — | High | — | Low | 0 | 750 |
| 5 | — | — | — | Low | 0 | 400 |
| 6 | High | — | — | — | 0 | 400 |
| 7 | — | — | High | — | 0 | 400 |
| 8 | — | — | — | — | 0 | 0 |

### Example 27

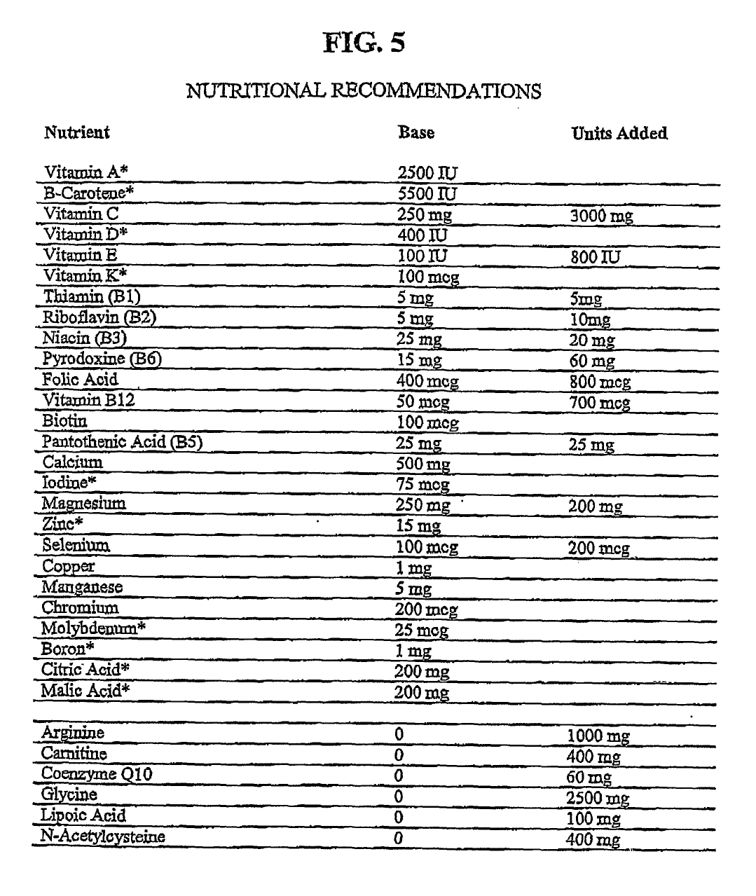

FIG. 5 is an example of a sample recommendation report outlining the formulation of the customized nutritional supplement. “Base” refers to the pre-customized level. The asterisk (*) indicates that the micronutrient was not customized.

The foregoing detailed description of the preferred embodiments and the appended figures have been presented only for illustrative and descriptive purposes. They are not intended to be exhaustive and are not intended to limit the scope and spirit of the invention. The embodiments were selected and described to best explain the principles of the invention and its practical applications. One skilled in the art can recognize that many variations can be made to the invention disclosed in this specification without departing from the scope and spirit of the invention.

What is claimed is:

1. A method for formulating a customized nutritional supplement suitable for a subject having a nutritional insufficiency comprising the steps of:
a) preparing a metabolite profile from a specimen of the subject in need of the customized nutritional supplement;
b) querying the metabolite profile of the subject determine at least one potential nutritional insufficiency in the subject by comparing the metabolite profile or at least one metabolite in the metabolite profile to a reference profile;
c) determining rations or effective amounts of select micronutrients that may shift the subject's metabolite profile towards the reference profile based on level of at least one metabolite in the metabolite profile of the subject; and
d) formulating the customized nutritional supplement by adjusting a base amount of micronutrients to have the ration or effective amount of the selected micronutrient.

2. The method as claimed in claim 2, further comprising the step of:
e) administering the customized nutritional supplement to the person over a period of time;

3. The method as claimed in claim 1, further comprising the step of:
e) preparing a subsequent metabolite profile of the subject; and
f) determining whether the subsequent metabolite profile shifted towards the reference profile.

4. The method as claimed in claim 1, wherein the metabolite profile of the subject is prepared from a single specimen of a body fluid from the subject.

5. The method as claimed in claim 1, wherein the specimen is selected from the group consisting of blood, urine, spinal fluid, or combination thereof.

6. The method as claimed in claim 1, wherein the metabolite profiles are prepared by quantifying at least one of the metabolites.

7. The method as claimed in claim 1, wherein the select micronutrients are selected from the group comprising vitamins, minerals, amino acids, and small molecules.

8. The method as claimed in claim 1, wherein one of the selected micronutrients is vitamin A.

9. The method as claimed in claim 1, wherein at least of one of the selected micronutrients is selected from the group consisting of vitamin B1, B2, B3, B6, B5, B12, folic acid.

10. The method as claimed in claim 1, wherein one of the selected micronutrients is biotin.

11. The method as claimed in claim 1, wherein the reference metabolic profile is correlated with micronutrients levels in a hypothetical healthy human.

12. The method as claimed in claim 1, wherein a combination of at least two metabolites in the subject's metabolite profile positively correlates with nutritional adequacy.

13. The method as claimed in claim 1, wherein at least one of the metabolites is an organic acid.

14. A composition prepared by
a) preparing a metabolite profile from a specimen of the subject in need of the customized nutritional supplement;
b) querying the metabolite of abnormalities that determine at least one potential nutritional insufficiency in the subject by comparing the metabolite profile or at least one metabolite in the metabolite profile to a reference profile;
c) determining rations or effective amounts of select micronutrients that may shift the subject's metabolite profile towards the reference profile based on level of at least one metabolite in the metabolite profile of the subject; and
d) providing pre-customized nutritional supplement having a base level of micronutrients; and
e) formulating the customized nutritional supplement by adjusting the pre-customized nutritional supplement to the rations or effective amount of the selected micronutrients.

15. The method as claimed in claim 14, wherein a combination of at least two metabolites in the subject's metabolite profile positively correlates with nutritional adequacy.

16. A method for formulating a customized supplement suitable for a subject having a nutritional insufficiency comprising the steps of:
a) identifying at least one potential micronutrient insufficiency in the subject based on at least one metabolite in a body fluid of the subject;
b) providing a base material having a plurality of micronutrients;
c) calculating a supplement amount of the at least one nutrient that is needed to overcome the nutritional insufficiency; and
d) adjusting the plurality of micronutrients so that the supplement amount of the at least one micronutrient is in the base material.

17. The method as claimed in claim 16, wherein the select micronutrients are selected from the group comprising vitamins, minerals, amino acids, and small molecules.

18. The method as claimed in claim 16, wherein the specimen is selected from the group consisting of blood, urine, spinal fluid, or combination thereof.

19. The method as claimed in claim 16, wherein the profile of the subject is prepared from a single specimen of a body fluid from the subject.

20. The methods for formulating customized nutritional supplement as disclosed herein.
